(19) United States
(12) Patent Application Publication
(10) Pub. No.: US 2025/0264665 A1
(43) Pub. Date: Aug. 21, 2025

(54) Large-Scale, Fast Optical Circuit Switching System

(71) Applicant: TELESCENT INC., Irvine, CA (US)

(72) Inventor: Anthony Stephen Kewitsch, Santa Monica, CA (US)

(73) Assignee: TELESCENT INC., Irvine, CA (US)

(21) Appl. No.: 19/054,851

(22) Filed: Feb. 16, 2025

Related U.S. Application Data
(60) Provisional application No. 63/554,769, filed on Feb. 16, 2024.

(51) Int. Cl. G02B 6/35; G02B 6/44

(52) U.S. Cl. CPC G02B 6/356; G02B 6/3578; G02B 6/3584; G02B 6/44528

(57) ABSTRACT

A large-scale, high-performance hybrid fiber optic switching system is comprised of a multiplicity of fast optical circuit switch (OCS) units with high-speed reconfiguration capabilities, wherein the fibers of each fast OCS unit are spliced to a large-scale robotic patch-panel system that enables nonblocking, any-to-any connectivity between thousands of ports without adding insertion loss. Integrated diagnostics to validate the optical performance of each fiber connection are also disclosed.

### RELATED APPLICATIONS

This application claims the benefit of U.S. application No. 63/554,769, filed Feb. 16, 2024, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to optical switching systems, and, more particularly, to optical switching systems, including large-scale, fast fiber optic switching systems, including fast-switching devices and robotic patch panel assemblies.

### BACKGROUND

Fiber optic matrix switches for use in large-scale applications (e.g., in production data center networks) are implemented to provide arbitrary fiber interconnections between M fiber optic inputs and N fiber optic outputs. These applications typically require low insertion loss and high port count or fiber count. Small-scale, higher insertion loss MEMS (Micro-Electro-Mechanical Systems) mirror switches, piezoelectric beam steering switches, and/or silicon photonics-based planar array switches are generally used when fast reconfiguration at low port counts is required and when higher insertion loss is acceptable.

Many types and sizes of fast matrix switches, e.g., optical circuit switches (OCS), are commercially available, with M inputs and N outputs ranging from ten up to a practical limit of about 320 fully nonblocking ports. These devices have relatively low port counts, and the insertion loss through the devices increases as the devices scale. As the number of ports is increased, the insertion loss and optical performance of the devices degrade due to the nature of the free space optics or cascaded planar waveguide design, longer beam paths and path differentials between collimators, fabrication limitations of collimating lenses and MEMS mirrors, etc.

The typical insertion loss of such devices is about 3 dB, and the typical return loss is 45 dB. While these devices may be able to reconfigure interconnections in about 10 ms, scaling these devices beyond a few hundred ports is challenging due to worsening insertion loss performance and decreasing reliability. Port density and insertion loss are major limitations of current solutions.

In an example illustrated in FIG. 1A, such fast-switching devices may utilize a MEMs mirror array to redirect light paths between opposing pairs of fixed collimator arrays. The transition from optical fiber to a free space collimated beam directed by a MEMs mirror results in significant insertion loss that is fundamental to the device's design. The fibers exiting the fixed input and output collimator arrays are then routed to a static fiber optic connector patch panel with LC, MPO, etc. connectors, which may result in an additional 0.15 dB per connector.

An alternative fast-switch design may utilize an input and output array of individually steerable collimators using piezoelectric actuators. The collimators are precisely controlled in angle by setting the high applied voltage to point the light beam such that it is directed from an input fiber to a particular output fiber of the array. Again, the transition from optical fiber to a free space collimated beam and back into an optical fiber results in significant insertion loss, which is fundamental to the design. Moreover, any slight misalignment within the device further increases the insertion loss.

Furthermore, larger port counts require larger arrays of collimators, longer free space propagation, and larger path length differences between collimators depending on the particular connection state. These factors contribute to a significant increase in insertion loss as the port counts increase.

Another fast-switching device design may be implemented using silicon photonics and a highly complex network of cascaded Mach-Zehnder switch elements. This design has an even higher loss (3 to 6 dB) and is even more challenging to scale to higher port counts. This approach may require complex, inefficient, and costly optical amplification elements integrated into the switch array to compensate for the significant excess insertion loss.

The scale and performance limitations of any of the above-mentioned fast-switching optical circuit devices limit the number of ports to a few hundred. An inherent drawback of these approaches is the significant increase of insertion loss as port count is increased, ranging from ˜1 dB for 100 ports to ˜3 dB for 300 ports. This high insertion loss causes the traditional approach of creating larger point count switches from small switch elements (e.g., using a three-tier Clos fabric) to be impractical because the losses would increase by a factor of three.

Also, attempting to improve the high insertion loss through optical amplification, e.g., by using EDFAs (Erbium Doped Fiber Amplifiers), is a costly and generally impractical way to overcome this increase in loss.

In addition, because such fast switch devices are each self-contained, arranging the devices into an array to increase the overall aggregate port count includes additional challenges due to port blocking or partitioning between the devices. That is, as shown in FIG. 1B, optical signals input into one fast switch device may not be redirected to an output of a different fast switch device due to the port-blocking partitions.

Therefore, it is of prime importance, and an object hereof, to provide a way to increase, that is, to multiply, the effective nonblocking radix of the fast-switching devices while minimizing insertion loss.

Alternatively, robotic fiber optic patch panels or cross-connects may achieve an order of magnitude larger port counts and lower insertion loss. However, the switching speeds of these devices are typically higher, e.g., on the order of 100 seconds.

As disclosed in U.S. Pat. No. 8,068,715, the entire contents of which are hereby fully incorporated herein by reference for all purposes, the Knots, Braids, Strands (KBS) algorithm can be used to control a robot to physically reconfigure very large numbers of optical fiber links without fiber entanglement or added insertion loss. The robot can arbitrarily reconfigure individual fibers within a dense arrangement of optical fibers by moving along an optimal, pre-planned trajectory that avoids fibers wrapping around and/or snagging others. The robot can reconfigure any internal fiber from one port to any other port within an array of connectors in about 100 seconds on average by following the path specified by the KBS algorithm. This robotic system scales gracefully in port count, totaling hundreds of ports up to tens of thousands of fully nonblocking ports, with each port corresponding to one, two, or a multiplicity of fibers.

Robotic switches have a typical insertion loss of 0.15 dB to 0.3 dB, far better than the 3 dB insertion loss of the fast-switching devices described above. The robotic design eliminates the significant insertion loss of fast-switching devices caused by the free space optical or cascaded planar waveguide designs, fabrication limitations of collimating lenses, coupling lenses, MEMS mirrors, beam misalignment, mechanical and thermal drift, etc. of such devices.

A fast-switching solution with substantially higher port density, lower insertion loss, and fast, parallel execution of fiber reconfiguration is important and requires new approaches.

### Glossary and Abbreviations

As used herein, the following terms have the following meanings:
AI means Artificial Intelligence.
GPU means Graphic Processing Unit.
OCS means optical circuit switch.
OTDR means Optical Time Domain Reflectometer.
MEMS means Micro-Electro-Mechanical System.

A fast Optical Circuit Switch (or fast OCS) is an optical switching system that establishes and reconfigures light paths with switching times in the nanosecond to microsecond range (typically ≤10 μs), enabling low-latency optical network reconfiguration.

The following table (Table I) summarizes switching speeds for some current fast OCS technologies.

TABLE I

| Rank | | | Number of |
|---|---|---|---|
| (speed) | Technology | Switching Speed | Ports |
| 1 | Semiconductor Optical | Nanosecond range | Very Low |
| | Amplifiers (SOAs) | (~1 to 10 ns) | (Few to 10) |
| 2 | Electro-optic switching | Nanosecond range | Low (10 to |
| | (LiNbO₃ or silicon | (~1 to 100 ns) | 100) |
| | photonics) | | |
| 3 | Acousto-Optic Tunable | Microsecond range | Low (10 to |
| | Filters (AOTFs) | (~1 to 10 μs) | 100) |
| 4 | Liquid Crystal on | Microsecond range | Low (10s to |
| | Silicon (LCoS) | (~10 to 100 μs) | 100) |
| 5 | Beam Steering with | Millisecond range | Medium (10 |
| | Piezoelectric Actuators | (~25 ms) | to 384) |
| | (Polatis/Huber Suhner) | | |
| 6 | Micro-Electro-Mechanical | Millisecond range | Medium (10 |
| | Systems (MEMS) (Calient, | (~50 ms) | to 320) |
| | Dicon, Lumentum) | | |

### SUMMARY

The present invention is specified in the claims and in the description below. The following summary is exemplary and not limiting. Presently-preferred embodiments are particularly specified in the dependent claims and the description of various embodiments.

A large-scale, high-performance hybrid fiber optic switching system is disclosed, comprised of a multiplicity of fast OCS units with high-speed reconfiguration capabilities, wherein the fibers of each fast OCS unit are spliced, preferably fusion spliced, to a large-scale robotic patch-panel system that enables nonblocking, any-to-any connectivity between thousands of ports without adding insertion loss. The robotic patch-panel system multiplies the fast OCS radix without increasing loss. At the same time, the switching speed of the overall system is <100 ms for fibers switched within a particular fast OCS block and ˜100 s for fibers crossing different fast OCS blocks. Network elements having fiber optic interconnects that require fast reconfiguration should be collocated on the same fast OCS block to optimize the overall execution time of the switching system. Integrated diagnostics to validate the optical performance of each fiber connection are also disclosed.

In one general aspect, a fast fiber optic switching system may include a large-scale robotic fiber optic patch-panel system and a multiplicity of fast OCS units, each unit with X fibers that can be reconfigured in parallel and within less than 10 seconds, where the fibers of each fast OCS unit are spliced to an equal number of input fibers of the robotic fiber optic patch-panel system. The system may include where the robotic fiber optic patch panel system has Y ports and can reconfigure each port in about one minute in a serial fashion. The system may include where the system provides reconfigurable, any-to-any connectivity between the Y ports. The system may include where Y is significantly larger than X. Preferably, Y is at least 2 times X.

Implementations may include one or more of the following features, alone or in combination(s):
The fiber optic switching system where Y is about 2,040, and X is about 136.
The fiber optic switching system where fibers of the fast OCS units are fusion-spliced to the large-scale robotic patch-panel system.
The fiber optic switching system where the Y ports of robotic fiber optic patch-panel correspond to simplex fiber ports with Y robotically reconfigurable fibers.
The fiber optic switching system where the Y ports of robotic fiber optic patch-panel correspond to duplex fiber ports with 2Y robotically pairwise reconfigurable fibers.
The fiber optic switching system is where a batch of reconfiguration commands can be executed in parallel within about one minute.
The fiber optic switching system where any of the X fibers can be connected to any of the Y ports.
The fiber optic switching system where insertion loss for all fibers of the fiber optic switching system is less than the insertion loss of an individual fast OCS unit with Y fibers (because the insertion loss of the fast OCS increases in proportion to the number of fibers in excess of X).
The fiber optic switching system includes a fiber-optic connector end-face cleaning system within the robotic fiber patch panel to maintain low insertion loss.
The fiber optic switching system further includes a fiber optic connector inspection system, which may include an OTDR (Optical Time Domain Reflectometer) that measures insertion loss and reflections within.
The fiber optic switching system extends out through external cables attached to the robotic patch panel.
The fiber optic switching system where the fast optical circuit switches may include one or more MEMS mirror arrays and/or one or more collimator arrays.
The fiber optic switching system where the fast optical circuit switches may include multiple opposing piezoelectric beam steering collimators.
The fiber optic switching system connects fast OCSs of different types, technologies, speeds, and/or capacities to the same robotic patch panel.
The fiber optic switching system where the fast OCSs are heterogeneous.

In another general aspect, a fiber optic switching system with greater than 144 ports comprises a multiplicity of fast OCS units with X fibers. The system may include where insertion loss of fast OCS units to switch X internal fibers increases in proportion to the number X. The fiber optic switching system may also include the fibers of each fast OCS unit being spliced to an equal number of input fibers of a large-scale robotic fiber optic patch panel. The fiber optic switching system may include the insertion loss of the robotic fiber optic patch panel with a number Y internal, independently reconfigurable fibers is independent of the number Y of fibers. The fiber optic switching system may include the fiber optic switching system, which enables any-to-any connectivity between the Y fibers, with Y significantly larger than X (i.e., Y is at least 2 times X). The fiber optic switching system may include where the insertion loss of the fiber optic switching system is less than possible for a Y port fast OCS unit alone.

Implementations may include one or more of the following features, alone or in combination(s):
The system where the insertion loss of each fast OCS is greater than 1 dB, and the insertion loss of the robotic fiber optic panel is less than 1 dB.
The system where fibers of the fast OCS units are fusion-spliced to the large-scale robotic patch-panel system.
The system includes a fiber-optic connector end-face cleaning system to maintain low insertion loss.
The system, including a fiber optic connector inspection system, may include an OTDR that measures the insertion loss and reflections within the fiber optic switching system and extends out through external cables attached to the robotic patch panel.
The system where Y is about 2,040, and X is about 136.
The system where the fast OCS units may include MEMS mirror arrays and/or collimator arrays.
The system where the fast OCS units may include multiple opposing piezoelectric beam steering collimators.
The fiber optic switching system connects fast OCSs of different types, technologies, speeds, and/or capacities to the same robotic patch panel.
The fiber optic switching system where the fast OCSs are heterogeneous.

In another general aspect, a high port count fast fiber optic switching system with greater than 144 total ports may include a multiplicity of fast OCS units, each unit with X fibers, the fibers of each fast OCS unit spliced to an equal number of input fibers of a large-scale robotic fiber optic patch-panel system having a connector array with Y ports, where the time to reconfigure a port is an additive combination of: (i) a first switching time t1 of the fast OCS to change all connections in a substantially parallel fashion; (ii) a second switching time t2 of the robotic patch-panel to change connections within a column of the connector array in a serial fashion; and (iii) a third switching time t3 of the robotic patch-panel to pass connections across a column of the connector array in a serial fashion.

Implementations may include one or more of the following features, alone or in combination(s):
The fiber optic switching system where t1 is about 10 ms, t2 is about 25 seconds, and t3 is about 10 seconds per column passed.
The fiber optic switching system where fibers of the fast OCS units are fusion-spliced to the large-scale robotic patch-panel system.
The fiber optic switching system connects fast OCSs of different types, technologies, speeds, and/or capacities to the same robotic patch panel.
The fiber optic switching system where the fast OCSs are heterogeneous.

The invention is further described with the following numbered examples.

Example Clause A: A fast fiber optic switching system with greater than 144 total ports, the system may include a large-scale robotic fiber optic patch-panel system; and a multiplicity of fast OCS units, each unit with X fibers that can be reconfigured in parallel and within less than 10 seconds, and with the fibers of each fast OCS unit spliced to an equal number of input fibers of the robotic fiber optic patch-panel system, where the robotic fiber optic patch panel system has Y ports and can reconfigure each port in about one minute in a serial fashion, and where the system provides reconfigurable, any-to-any connectivity between the Y ports, and where Y is significantly larger than X (i.e., Y is at least 2 times X).

Example Clause B: The fiber optic switching system of Example Clause A, where Y is about 2,040, and X is about 136.

Example Clause C: The fiber optic switching system of Example Clause A or

Example Clause B, where the Y ports of the robotic fiber optic patch-panel correspond to simplex fiber ports with Y robotically reconfigurable fibers.

Example Clause D): The fiber optic switching system of any of Example Clauses A-C, where the Y ports of robotic fiber optic patch-panel correspond to duplex fiber ports with 2Y robotically pairwise reconfigurable fibers.

Example Clause E: The fiber optic switching system of any of Example Clauses A-D, where a batch of reconfiguration commands can be executed in parallel within about one minute.

Example Clause F: The fiber optic switching system of any of Example Clauses A-E, where any X fibers can be connected to any of the Y ports.

Example Clause G: The fiber optic switching system of any one of Example Clauses A-F, where insertion loss for all fibers of the fiber optic switching system is less than the insertion loss of an individual fast OCS unit with Y fibers.

Example Clause H: The fiber optic switching system of any of Example Clauses A-G, further including a fiber-optic connector end-face cleaning system within the robotic fiber patch panel to maintain low insertion loss.

Example Clause I: The fiber optic switching system of any one of Example Clauses A-H, further including a fiber optic connector inspection system may include an OTDR that measures insertion loss and reflections within the fiber optic switching system and extending out through external cables attached to the robotic patch-panel.

Example Clause J: The fiber optic switching system of any of Example Clauses A-I, where the fast optical circuit switches may include MEMS mirror arrays and/or collimator arrays.

Example Clause K: The fiber optic switching system of any of Example Clauses A-J, where the fast optical circuit switches may include multiple opposing piezoelectric beam steering collimators.

Example Clause K2: The fiber optic switching system of any of Example Clauses A-K, where the fast optical circuit switches may be of different types, technologies, speeds, and/or capacities to the same robotic patch panel.

Example Clause K3: The fiber optic switching system of any of Example Clauses A-K2, where the fast optical circuit switches are heterogeneous.

Example Clause K4: The fiber optic switching system of any of Example Clauses A-K3, where fibers of the fast OCS units are fusion spliced to the large-scale robotic patch-panel system.

Example Clause L: A fiber optic switching system with greater than 144 ports, the system may include a multiplicity of fast OCS units with X fibers, where insertion loss of fast OCS units to switch X internal fibers increases in proportion to the number X, and the fibers of each fast OCS unit are spliced to an equal number of input fibers of a large-scale robotic fiber optic patch panel, and the insertion loss of the robotic fiber optic patch panel with a number Y internal, independently reconfigurable fibers is independent of the number Y of fibers, and the fiber optic switching system enables any-to-any connectivity between the Y fibers, with Y significantly larger than X, and where the insertion loss of the fiber optic switching system is less than what would be possible for a Y port fast OCS unit alone.

Example Clause M: The system of Example Clause L, where the insertion loss of each fast OCS is greater than 1 dB, and the insertion loss of the robotic fiber optic panel is less than 1 dB.

Example Clause N: The system of Example Clause L or Example Clause M, further includes a fiber-optic connector end-face cleaning system to maintain low insertion loss.

Example Clause O: The system of any one of Example Clauses L-N, further including a fiber optic connector inspection system may include an OTDR that measures the insertion loss and reflections within the fiber optic switching system and extends out through external cables attached to the robotic patch panel.

Example Clause P: The system of any of Example Clauses L-O where Y is about 2,040, and X is about 136.

Example Clause Q: The system of any of Example Clauses L-P, where the fast OCS units may include MEMS mirror arrays and/or collimator arrays.

Example Clause R: The system of any of Example Clauses L-Q, where the fast OCS units may include multiple opposing piezoelectric beam steering collimators.

Example Clause R2: The fiber optic switching system of any of Example Clauses L-R, where the fast optical circuit switches may be of different types, technologies, speeds, and/or capacities to the same robotic patch panel.

Example Clause R3: The fiber optic switching system of any of Example Clauses L-R2, where the fast optical circuit switches are heterogeneous.

Example Clause R4: The fiber optic switching system of any of Example Clauses A-R3, where fibers of the fast OCS units are fusion spliced to the large-scale robotic patch-panel system.

Example Clause S: A high port count, fast fiber optic switching system with greater than 144 total ports, the system may include a multiplicity of fast OCS units, each unit with X fibers, the fibers of each fast OCS unit spliced to an equal number of input fibers of a large-scale robotic fiber optic patch-panel system may include a connector array with Y ports, where the time to reconfigure a port is an additive combination may include of: (i) a first switching time t1 of the fast OCS to change all connections in a substantially parallel fashion, (ii) a second switching time t2 of the robotic patch-panel to change connections within a column of the connector array in a serial fashion, and (iii) a third switching time t3 of the robotic patch-panel to pass connections across a column of the connector array in a serial fashion.

Example Clause T: The system as in Example Clause S, where t1 is about 10 ms, t2 is about 25 seconds, and t3 is about 10 seconds per column passed.

Example Clause U: The fiber optic switching system of any of Example Clauses T or S, where fibers of the fast OCS units are fusion spliced to the large-scale robotic patch-panel system.

### BRIEF DESCRIPTION OF THE DRAWINGS

Various other objects, features, and attendant advantages of the present invention will become fully appreciated as the same becomes better understood when considered in conjunction with the accompanying drawings, in which like reference characters designate the same or similar parts throughout the several views and wherein:

FIG. 1A shows prior art fast optical circuit switches based on MEMS mirror array or piezoelectric beam steering;

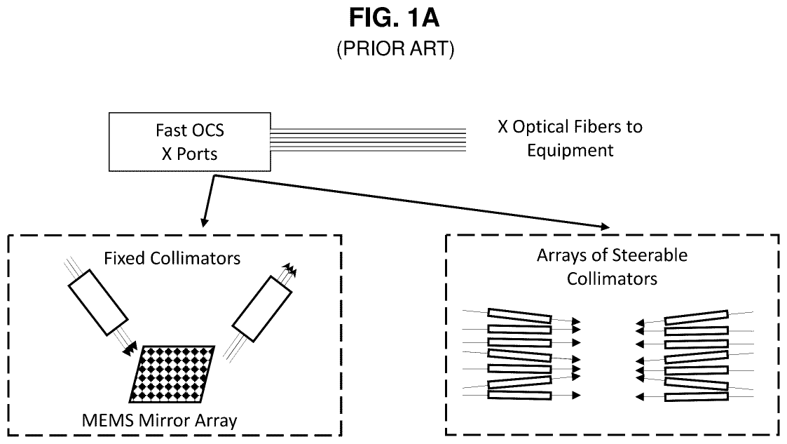

FIG. 1B shows port blocking limitations when a plurality of separate and independent fast optical circuit switches is utilized to achieve a large port count;

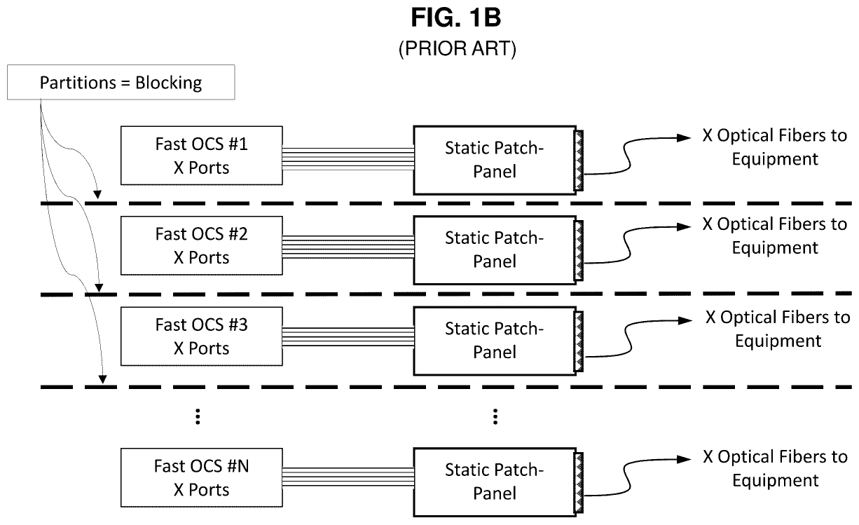

FIG. 2A shows a block diagram of a large-scale optical switching system according to embodiments hereof;

FIG. 2B shows a block diagram of a large-scale optical switching system according to embodiments hereof;

FIG. 3 shows a block diagram of a portion of a large-scale optical switching system according to embodiments hereof;

FIG. 4 shows a block diagram of a portion of a large-scale optical switching system according to embodiments hereof;

FIG. 5 shows a block diagram of a large-scale optical switching system according to embodiments hereof;

FIG. 6 is a graph depicting the relationship between insertion loss and port count for fast OCS;

FIG. 7 is a schematic diagram of the front view of the connector array of a robotic patch panel divided into rows and columns, with the fast OCS connections distributed across both rows and columns to improve the switching time between ports across the connector array;

FIG. 8 shows a block diagram of a large-scale optical switching system according to embodiments hereof; and

FIG. 9 shows a block diagram of a large-scale optical switching system according to embodiments hereof.

### DETAILED DESCRIPTION

In general, a large-scale optical switching system is provided.

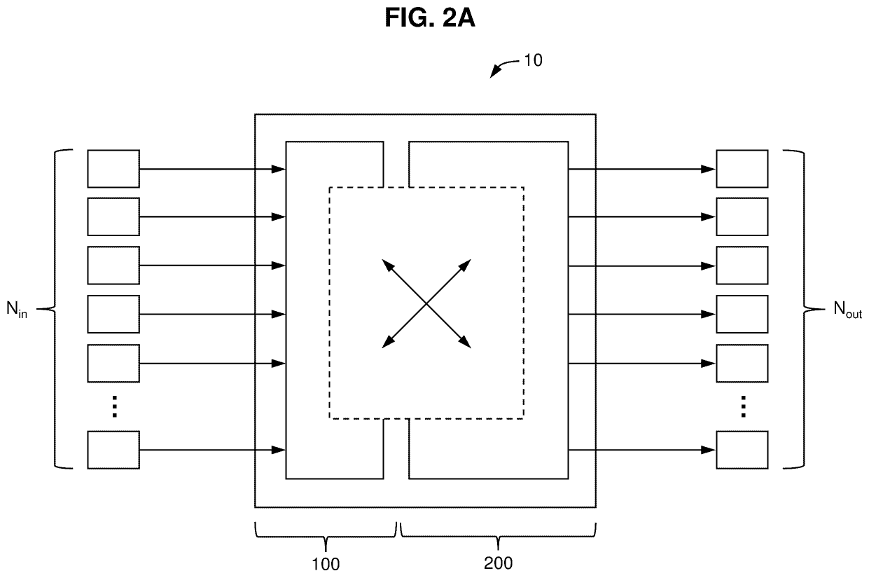

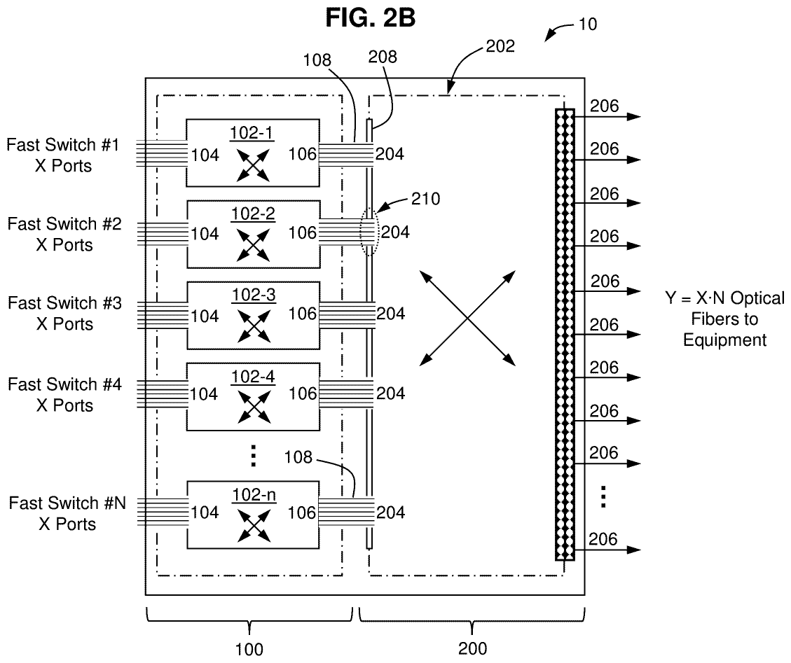

FIGS. 2A-2B show generalized block diagrams of a large-scale optical switching system 10. In some embodiments, as shown in FIG. 2A, the large-scale optical switching system 10 (also referred to herein as simply the system 10) includes a first-stage switching system 100 and a second-stage switching system 200 arranged in series. The system 10 may be configured within an optical network to receive optical signals from input network elements N_in (e.g., optical equipment) and to direct the signals to particular output network elements N_out (e.g., other optical equipment) as required. As described herein, an optical signal at any of the system's input ports may be directed through the system 10 to any of the system's output ports. Because the first and second stages 100 and 200, are in series, the inputs to the system 10 include inputs to the first stage 100, and the outputs from the system 10 include outputs from the second stage 200.

In general, input and/or output network elements N_in, N_out having fiber optic interconnects that require fast reconfigurations (e.g., <100 ms) may be accommodated in the first stage switching system 100, and network elements N_in, N_out having fiber optic interconnects that do not require such fast reconfigurations (e.g., that can operate with ˜100-sec reconfigurations) may be accommodated in the second stage switching system 200. This will be described in detail elsewhere herein.

In some embodiments, as shown in FIG. 2B, the first stage 100 may include one or more fast matrix switch modules 102-1, 102-2, 102-3, 102-4 . . . 102-n (individually and collectively 102), with each module 102 including several fiber optic input ports 104 controllably switchable (through the module 102) to any one of a number of fiber optic output ports 106. For example, a fast matrix switch module 102 may include M fiber optic inputs 104 and N fiber optic outputs 106 (with M and N including any integers) such that an optical signal at any one of the M inputs 104 may be directed to any one of the N outputs 106 through the respective module 102. While the modules 102 described herein may be described as each including M inputs 104 and N outputs 106, it is understood that this is for ease of understanding and that the modules 102 may each include different numbers of inputs 104 and different numbers of outputs 106, and that the modules 102 need not match.

The fast matrix switch modules 102 may implement any fast optical switching technologies, e.g., OCS using MEMS mirror switches, piezoelectric beam steering switches (e.g., steerable optical collimators), silicon photonics-based planar array switches (e.g., cascaded Mach-Zehnder switch elements), and so forth.

For a particular system 10, the fast matrix switch modules 102 may be heterogeneous and may include OCSs of different types (e.g., different speeds, capacities, technologies, etc.).

In some embodiments, the fast switch modules 102 preferably provide switching speeds of <100 ms (and preferably about 10 ms), depending on the port count of the modules 102. To keep the insertion loss and/or return loss of the modules 102 at an acceptable level (e.g., <3 dB and >45 dB, respectively), the port count of the fast switch modules 102 may be kept somewhat small, e.g., on the order of about ten input and output ports 104, 106 (resulting in about 1 dB loss at this scale) to about 320 input and output ports 104, 106 (resulting in about 3 dB loss at this scale). As the port count is scaled upward, the insertion loss through the switch modules 102 also may increase, thereby making the modules 102 overly lossy at larger scale. As such, it may be preferable to limit the port count of the modules 102 to their upper specified limit, e.g., to about 320 or fewer input and output ports 104, 106.

Given that each fast matrix switch module 102 may include a limited number of input and output ports 104, 106, it may be preferable to include a plurality of fast switch modules 102 (e.g., an array of modules 102) at the input to the overall optical switching system 10 to effectively increase the total number of input and output ports 104, 106 to the desired large scale of the system 10. For example, if it is desired to scale the system 10 to 2,040 input/output ports, and if each fast switch module 102 includes a total of 136 input/output ports 104, a total of 15 fast switch modules 102 may be provided at the input to the system 10 (136×15=2,040).

As described above, a particular fast switch module 102 may direct an optical signal from any one of its M input ports 104 to any one of its N output ports 106. However, because each fast switch module 102 is generally self-contained and separate from each of the other fast switch modules 102, an optical signal at a particular input port 104 of a first fast switch module 102-1 may not be directed through the first stage switching system 100 to a particular output port 106 of a second fast switch module 102-2 separate from the first fast switch module 102. This scenario may be referred to as having “partitions” or port blocking between each of the plurality of fast switch modules 102 that essentially block switching between separate modules 102.

To account for this, in some embodiments, as shown in FIG. 2B, the second stage switching system 200 may include a large-scale robotic patch panel assembly 202 that provides a number of input ports 204 that preferably equals or exceeds the aggregate number of output ports 106 provided by the plurality of fast switch modules 102. For example, using the example above, the robotic patch panel assembly 202 may include 2040 input ports 204 to match the 2,040 output ports 106 provided by the first stage switching system 100. The robotic patch panel assembly 202 also may provide a corresponding number of output ports 206 with the functionality to direct an optical signal from any of its input ports 204 to any of its output ports 206.

In some embodiments, the robotic patch panel assembly 202 may include a highly scalable and modular robotic optical cross-connect switch device with low loss and scalability to high port counts as disclosed in U.S. Pat. No. 8,068,715, the entire contents of which is hereby fully incorporated herein by reference for all purposes.

In some embodiments, as shown in FIG. 2B, the patch panel assembly 202 includes an input panel 208 that provides the input ports 204 to the assembly 202. In some embodiments, each output 106 of each fast switch module 102 may be connected directly to a corresponding input 204 at the patch panel's input panel 208. In some embodiments, each output 106 of each fast switch module 102 may include an output fiber section 108 that is spliced directly into the patch panel's input panel 208 (fiber-to-fiber) at each corresponding patch panel input 204. As such, none of the fast switch module outputs 106 (i.e., none of the output fiber sections 108), and none of the patch panel's input ports 204 at the input panel 208 may include traditional optical connectors (e.g., no LC, MU, SC, SN, MDC, MPO, MTP, MMC, MDC, expanded beam EBO, etc., optical connectors). Instead, the input panel 208 may provide input fiber ends at each input port 204 that may be spliced directly with the corresponding output fiber ends of each output fiber section 108 from each fast switch module 102. This is designated, e.g., by the splicing connection location 210 in FIG. 2B. In this way, insertion loss through traditional optical connectors is avoided so that the insertion loss between the outputs 106 of the fast switch modules 102 and the inputs 204 of the patch panel assembly 202 may be minimized.

For all embodiments, while any mechanical splicing technique between the optical fibers may be utilized, fusion splicing is preferred.

Additional embodiments and details of the system 10 will be described through several detailed examples. The examples provided below are chosen to illustrate various embodiments and implementations of the system 10, and those of ordinary skill in the art will appreciate and understand, upon reading this description, that the examples are not limiting and that the system 10 may be used in different ways.

### Switching Scenario #1—Fast Switching Required

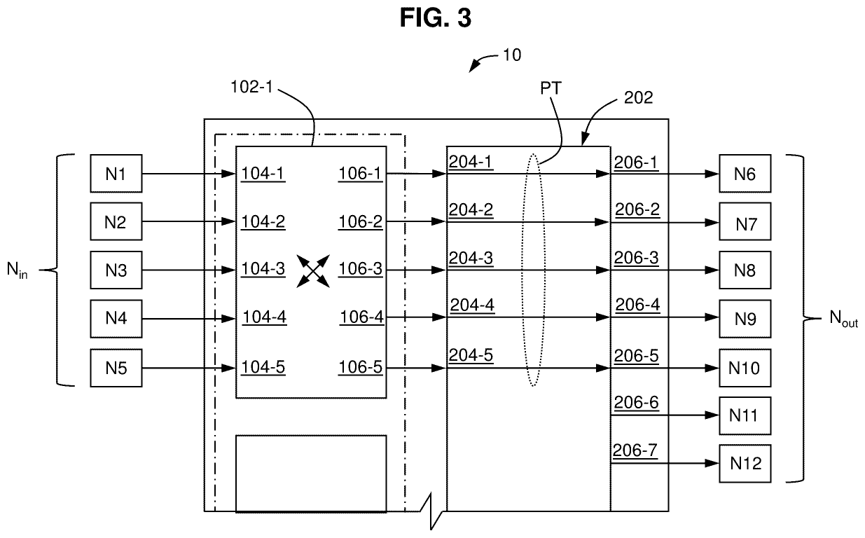

In a first example, FIG. 3 shows a generalized portion of the system 10, including an example fast switching module 102-1 configured with the robotic patch panel assembly 202. As shown, five input network elements N1-N5 (e.g., optical equipment) are configured with the fast switch module 102-1 at the input to the system 10, with each input network element configured with its own unique corresponding fast switch module input 104. For example, element N1 is connected to input port 104-1, element N2 is connected to input port 104-2, element N3 is connected to input port 104-3, and so on.

FIG. 3 also shows seven output network elements N6-N12 (e.g., other optical equipment) configured with the output of the system 10, with each output network element configured with its own unique corresponding patch panel output 206. For example, element N6 is connected to output 206-1, element N7 is connected to output 206-2, element N8 is connected to output 206-3, and so on.

In a first switching scenario, an optical signal from any input network element N1-N5 may require fast interconnection switching to any of the output network elements N6-N10 (but not necessarily to the output network elements N11-N12). Because of this fast-switching requirement, it is preferable that each of the input network elements N1-N5 and each of the output network elements N6-N10 are configured with the respective inputs 104 and outputs 106 of the same fast switch module 102-1. In this way, interconnection switching between any of the input elements N1-N5 to any of the output elements N6-N10 may happen within the fast switch module 102-1 with preferable speeds of <100 ms.

Furthermore, the robotic patch panel assembly 202 may be configured to provide a direct pass-through PT of the optical signals from its corresponding input ports 204-1, 204-2, 204-3, 204-4, 204-5 to its corresponding output ports 206-1, 206-2, 206-3, 206-4, 206-5 such that as the fast interconnect switching occurs within the fast switch module 102-1, no additional switching is required within the robotic patch panel 202. As such, the optical signals may simply pass through the patch panel 202 without significant added switching time or loss. The pass-throughs PTs may be dedicated, remain configured indefinitely, and/or reconfigured as network requirements change or otherwise as needed.

While the pass-throughs PTs, in this example, are depicted as extending between the patch panel's input ports 204-1, 204-2, 204-3, 204-4, 204-5 and the patch panel output ports 206-1, 206-2, 206-3, 206-4, 206-5 straight across the patch panel's bay, it is understood that this is shown for ease of understanding and that the pass-throughs PTs for this example may be configured between any of the patch panel's input ports 204-1, 204-2, 204-3, 204-4, 204-5 and any of the total patch panel output ports 206.

It also is understood that the example above is meant for demonstration and that other numbers of input network elements may be configured with other numbers of input ports 104 and that other numbers of output network elements may be configured with other numbers of output ports 206 as required.

### Switching Scenario #2—Fast Switching not Required

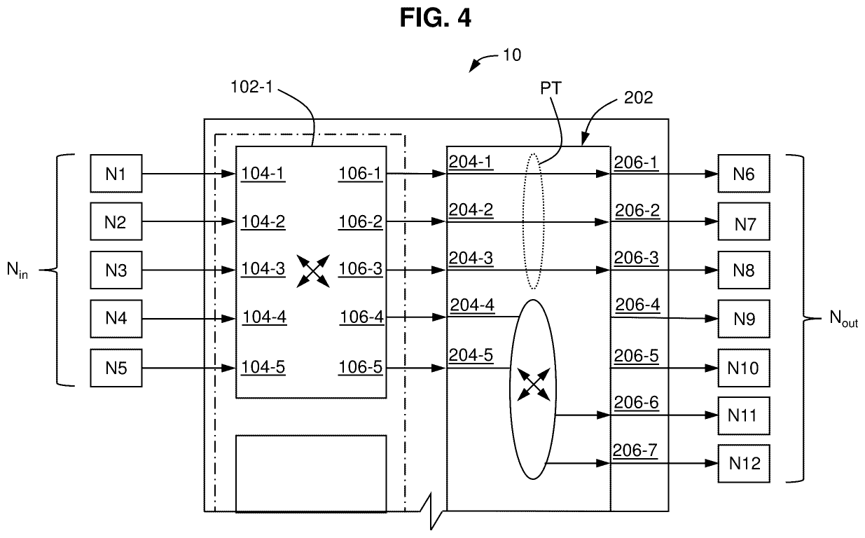

In a second example, FIG. 4 shows the generalized portion of the system 10 of FIG. 3. In this example scenario, it is desired to direct an optical signal from an input network element N_in configured with the input 104 of the fast switch module 102-1 to one or more output network elements N_out that are not connected directly to an output 106 of the same fast switching module 102-1 (i.e., that do not include a dedicated pass-through PT within the patch panel 202 leading to an output 104 of the first module 102-1). Given this, the switching may not occur within the first fast switch module 102-1 (within the first stage 100), and instead, the switching occurs within the robotic patch panel assembly 202 (within the second stage 200).

To expand on this example, as shown in FIG. 4, it may be desired to redirect optical signals from input network elements N4 and N5 to output network elements N11 and N12, respectively, with output elements N11 and N12 not connected to the first fast switch module 102-1 via a dedicated pass-through PT within the patch panel 202. In this example, the first fast switch module 102-1 may receive the optical signals from the network elements N11, N12 at its input ports, e.g., at ports 104-4, 104-5, and may direct the signals to its output ports 106-4, 106-5, respectively. The patch panel assembly 202 may receive the signals at its input ports 204-4, 204-5, and may reconfigure optical paths within its bay to extend from its input ports 204-4, 204-5 to its output ports 206-6, 206-7, respectively. In this way, the signals may enter the patch panel 202 and be redirected to the appropriate output ports 206-6, 206-7 to be provided to the output network elements N11, N12 as desired.

In this example, because the switching occurs within the second stage 200, it is preferable that the speed requirement of the interconnection switching be on the order of 100 sec (e.g., that of the second stage 200).

It is understood that the example described above is for demonstration and that optical signals at any first stage 100 input 104 may be directed to any second stage 200 input 204 and then to any second stage 200 output 206 and then to any output network element N_out.

Given example scenarios #1 and #2 above, the following are apparent:

First, an optical signal from any input network element N_in may be directed to any output network element N_out via the system 10.

Second, for interconnections that require fast switching (e.g., <100 ms) between a particular input element N_in and a target output element N_out, the particular input element N_in may be configured with an input 104 to a particular fast switch module 102, and the second stage 200 may provide a pass-through PT between the target output network element N_out and the patch panel's input port 204 associated with the output 104 of the particular fast switch module 102. In this way, the interconnection switching may be accommodated within the particular fast switch module 102 within the first stage switch system 100 at the fast-switching speed.

Third, for interconnections that may not require fast switching between a particular input element N_in and a target output element N_out (e.g., that may operate at speeds ˜100 sec), the fast switch module 102 may simply pass the optical signal to the patch panel assembly 202. The patch panel assembly 202 may perform the necessary interconnections between the output 106 of the fast switch module 102 and the target output element N_out.

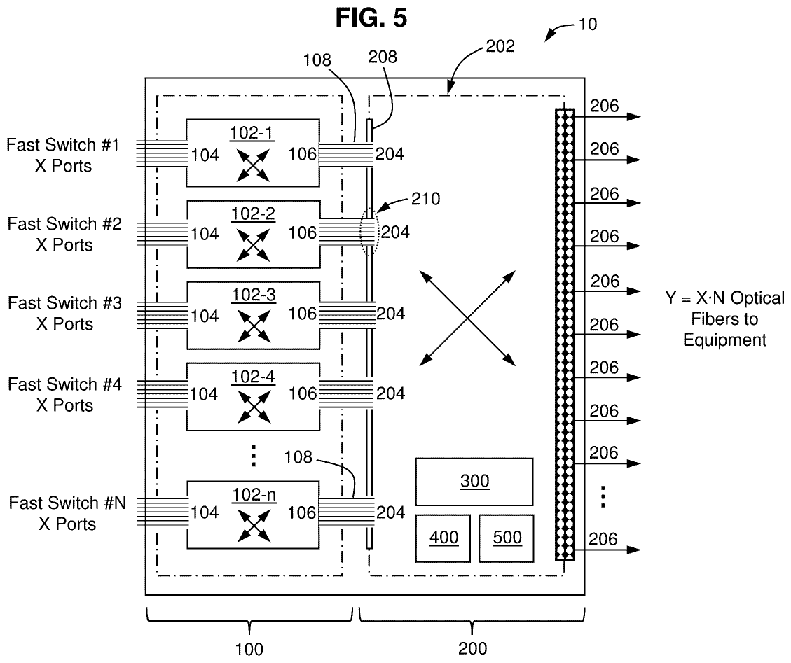

In some embodiments, as shown in FIG. 5, the system 10 may include a controller 500 configured to control and manage the operations and different functionalities of the system 10. In some embodiments, the controller 500 may include and implement the non-entanglement algorithm (e.g., the Knots, Braids, Strands (KBS) algorithm) as described in other sections.

In some embodiments, the controller 500 may also orchestrate the multitude of interconnections within the system 10 to accommodate the overall network requirements properly. For example, the controller 500 may identify network interconnections requiring fast switching and configure system 10 to provide these fast-switching interconnections within the first stage 100. In another example, the controller may identify network interconnections that may not require such fast switching and may configure the system 10 to provide these interconnections within the second stage 200. It may be preferable for the controller 500 to make such determinations in real-time (or near real-time) so that as the overall network requirements may change, the controller 500 may reconfigure the system 10 as needed. In some embodiments, the controller 500 may be in wired or wireless communication with other equipment and/or elements (e.g., with a network management system) so that it may receive information and/or commands regarding the overall network requirements and make the necessary configurations on-demand.

It is understood that the controller 500 may perform other functionalities required for the system 10 to perform as described herein or otherwise.

### Discussion

The switching system disclosed herein provides low insertion loss independent of the number of ports.

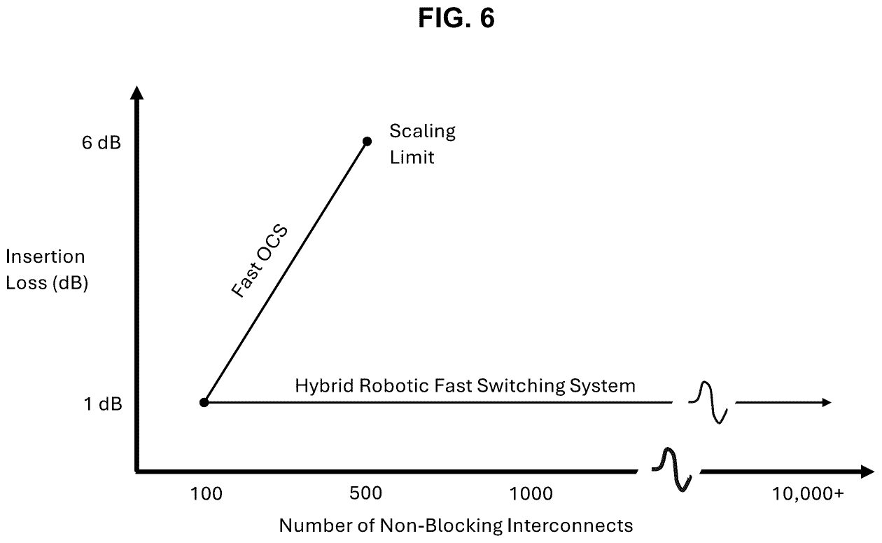

FIG. 6 is a graph depicting the relationship between insertion loss and port count for fast OCSs in which the insertion loss increases significantly with port count. This severely limits the applicability of fast OCS to applications with less than a few hundred ports. Specifically, a 96-port OCS typically has an insertion loss of at least 1 dB, and a 500-port OCS typically has an insertion loss of 6 dB or more. This is illustrated in the top line of the graph in FIG. 6.

For fast OCSs, the optical fibers terminating at the collimating lenses at one end are directly terminated with connectors at the other end. These connectors can then be plugged into the back of a static patch panel.

The insertion loss of splices is typically <0.02 dB, essentially zero loss compared to the loss of the fast OCS.

In comparison, insertion loss of the hybrid fast OCS-robotic patch panel does not increase with port count. The addition of the robotic patch panel does not increase the insertion loss of the OCS because the robotic patch panel has the same or potentially better insertion loss than a patch panel that is typically part of a standalone OCS switching unit. That is, at 96 ports, the insertion loss of the hybrid approach is 1 dB, like the fast OCS alone. The robotic patch panel scales to 1,000s and 10,000s of ports with the same insertion loss, as shown in the bottom line of the graph in FIG. 6. This key advantage makes this system ideally suited for large data centers, fiber-dense networks, and AI GPU compute clusters with 500,000 fiber links.

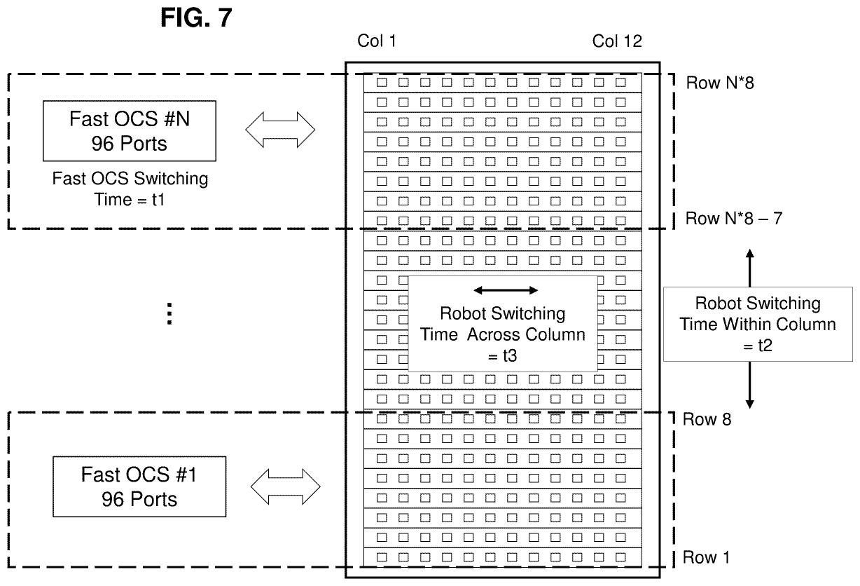

The hybrid fast OCS-robotic patch panel offers unique reconfiguration time characteristics. The switching time is not fully specified by a switching time but instead by three very different switching times. FIG. 7 is a schematic diagram of the front view of the connector array of a robotic patch panel divided into rows and columns. The fast OCS connections are distributed across both rows and columns with a fast-switching time of t1 between ports across the connector array originating from a particular fast OCS unit. Time t1 is typically 10 ms. The robotic patch-panel reconfiguration time is described by time t2, the time for the robot to reconfigure fibers between the ports within the same column, and time t3, the time for the robot to reconfigure fibers between ports in different columns. Time t2 is typically 25 seconds, and time t3 typically adds 10 seconds per column that must be crossed to the total reconfiguration time. If five columns need to be crossed, this can add approximately 50 seconds to the process. Therefore, spreading the fast OCS ports across the columns of the robotic patch panel allows the bulk of the inter-column switching to be performed by the fast OCS rather than by the robotic patch panel, thereby avoiding 50 seconds. Note that the reconfiguration time of the robotic patch panel is relevant only to making inter-OCS connections, where it would be some additive combination of times t2 and t3. The fast OCS alone switches those connections within a particular fast OCS unit within the time t1.

In a particular example of an AI GPU compute cluster networked using fiber interconnects, given a certain target network topology for a particular compute workflow, the control system that directs the hybrid fast OCS-robotic patch-panel reconfiguration will define a “cost function” weighted according to the time to perform reconfigurations, some of which will be performed serially by the robot. This cost function is minimized per the Dykstra algorithm, etc. The optimal allocation of interconnects is determined so that the hybrid fast OCS-robotic patch panel can perform a batch sequence of port-by-port switching instructions in the shortest time. In several applications, it is important to perform this batch reconfiguration in the shortest time and avoid keeping the costly GPUs idle between compute workflows.

In some embodiments, e.g., as shown in FIG. 5, the system 10 may include an automated fiber end-face cleaning system 300 configured to clean fiber optic end-faces within the system 10 (e.g., within the patch panel assembly 202). After cleaning, the insertion loss and back reflection of each cleaned connector may be measured and validated using measurement and test equipment 400, e.g., an Optical Time Domain Reflectometer (OTDR). The OTDR test signal may be launched through the robotic patch panel assembly 202 in combination with the fast switch modules 102 so that the signal propagates out to the external network connections. This enables the insertion loss and back reflection performance of the fast switch modules 102 and of the robotic patch panel 202 interconnections to be measured, thereby verifying that a good connection has been provisioned.

In one example, if an interconnection within the robotic patch panel 202 is determined to have higher insertion loss than expected (e.g., greater than 0.3 dB), the respective connection may be re-cleaned, re-installed, and re-tested. Alternatively, if a fast switch module 102 is determined to have a higher insertion loss than expected, a different fiber path having a lower associated loss may be provisioned by the system 10. The automation of this process results in a considerable simplification and improvement of the interconnection process and performance.

In some embodiments, the outputs 206 of the robotic patch panel assembly 202 may include an array of Y pluggable fiber optic connector ports subdivided into a multiplicity of rows and columns. Any of the fiber connectors plugged into the array may be arbitrarily reconfigured by the robotic patch panel 202.

The robotic patch panel 202 includes control, sensing, and power means and a telescopic robotic arm with a small form factor gripper that can engage, transport, and disengage any fiber optic connector(s) located within the assembly's dense interconnect volume from a first output port 206 to a second output port 206 within the interior volume of the fiber optic patch panel 202.

Each row of output connectors within the array is enabled to shift to the left and/or to the right independent of the other rows. The robot patch panel 202 includes actuators (e.g., an array of linear stepper motor actuators or other motorized means) attached to the rows and configured to cause the precise movement of any row between any of three positions: left, right, and center. Each row of connectors is preferably able to move laterally a distance of approximately the spacing between each of the columns of the patch-panel connector array (e.g., in the range of 25 to 35 mm). The number of rows is typically in the range of 12 to 200.

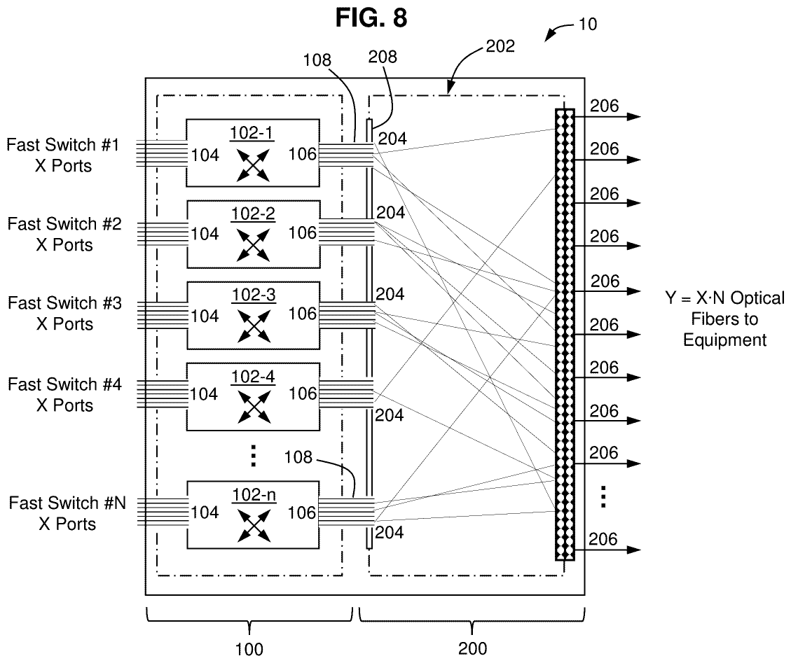

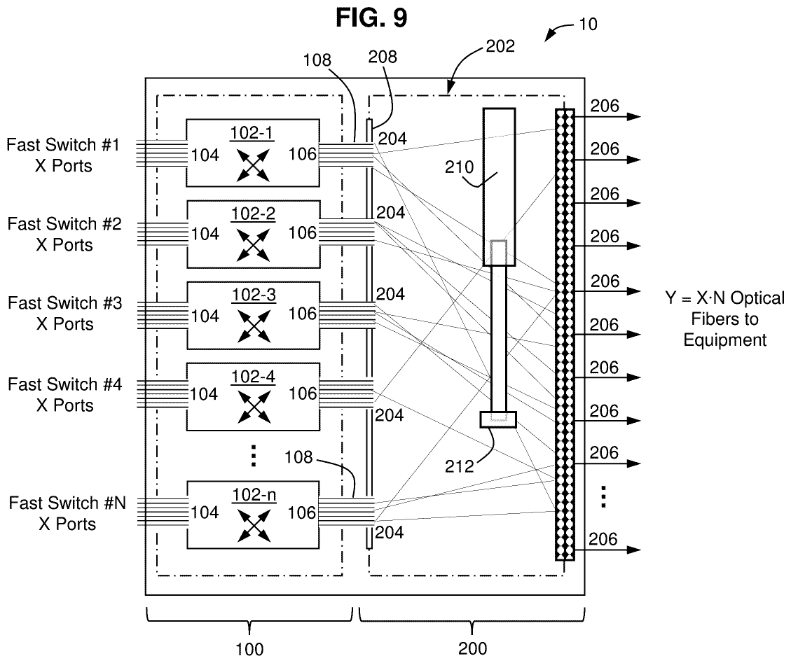

FIG. 8 shows an example of arbitrary fiber optic interconnections enabled between the input and output ports 204, 206 within the robotic patch panel assembly 202, and FIG. 9 shows a robotic arm 210 and gripper 212 configured to engage interconnections within the robotic patch panel assembly 202.

In some embodiments, as shown in FIG. 9, the patch panel's robotic arm 210 is configured to descend into the fiber connector array along the inner back panel of output ports 206 to engage any target connector. The connector row containing the target connector to be reconfigured by the robot is moved to the center position to enable the gripper 212 to access the selected connector. All other rows above this row are moved to either the left or right positions, as determined by the KBS non-entanglement algorithm, which drives the shuffling of rows and motion of the robotic arm and gripper. The non-entanglement algorithm coordinates the movement of the robot and robot actuators and resides on a controller within the system 10 or on a remote physical or virtual server.

The robotic gripper 212 at the end of a robotic arm 210 includes a narrow form factor (<20 mm in width) to enable the gripper 212 to descend 1 to 2 meters and to move between the columns of the patch-panel connector array and the optical fibers arbitrarily connected therein.

The robotic patch panel assembly 202 also may include a frame with typical dimensions of about 2.5 m tall, 1.0 m deep, and 1.0 m wide. Typical patch panel assemblies 200 may contain about 100 to 5,000 fiber optic connector ports.

In addition, the robotic patch panel assembly 202 may include a passive slack fiber management system comprised of a multiplicity of spring-loaded fiber optic cable tensioning reels and/or pulleys such as those disclosed in U.S. Pat. Nos. 8,488,938 and 10,345,526, the entire contents of both of which are hereby fully incorporated herein by reference for all purposes. Fiber optic connector ports may include any of the various industry standard types, including LC, MU, SC, SN, MDC, MPO, MTP, MMC, MDC, expanded beam EBO, etc. Depending on the number of fibers per connector, individual or bundles of single-mode or multimode fiber may be managed by the tensioning system.

### Example: Acceleration of Machine Learning Using High Port Count, Low Loss, Fast Optical Switching System

The fiber optic switching systems shown in FIGS. 5, 8, and 9 have particular benefits when used to program and optimize the physical network topology of a machine learning cluster. For example, a recent paper [TopoOpt: Co-optimizing Network Topology and Parallelization Strategy for Distributed Training Jobs, W. Wang et al., NSDI23] describes the use of a robotic patch-panel to optimize the interconnect topology between GPUs (Graphical Processing Units) and accelerate the machine learning training process by 3.4 times.

For large-scale fiber optic network applications within machine learning clusters, it may be advantageous to interconnect GPUs and/or electronic packet switches that require relatively frequent reconfigurations to the subset of contiguous ports corresponding to each fast OCS unit with <100 ms switching speed. Those GPU and/or electronic packet switch fiber interconnections experiencing relatively infrequent changes can span multiple fast OCS units and thus be reconfigured by robotic patch panels with ˜100-second switching speed without introducing excessive delays. This hybrid approach preserves the ability to selectively switch blocks of ports at high speed while accomplishing the competing requirements for both large-scale and low insertion loss/back reflection.

### CONCLUSION

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components unless expressly so stated.

Throughout the description and claims, the phrase “Y is significantly larger than X,” if used, means that Y is at least 2 times X.

It will be appreciated that variations to the embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

The present invention also covers the exact terms, features, values, and ranges, etc., in case these terms, features, values, and ranges, etc. are used in conjunction with terms such as “about,” “around,” “generally,” “substantially,” “essentially,” “at least,” etc. (i.e., “about 3” shall also cover exactly 3 or “substantially constant” shall also cover exactly constant).

Those of ordinary skill in the art will realize and appreciate, upon reading this description, that the term “substantially identical length” means the same length, within ±10%, preferably within ±5%. Similarly, as used herein, the term “substantially straight” means “straight,” within ±10%, preferably within ±5%, and the term “substantially equidistant” (or “substantially equal distance”) means “equidistant” within +10%, preferably within +5%; and “without substantially bending” means “without bending more than 10%, preferably without bending more than 5%. Thus, in general, as used herein, including in the claims, the term “substantially” when applied to a property (e.g., length, straightness, equality, distance, shape, etc.) means within 10 percent, and preferably within 5 percent of that property.

Use of exemplary language, such as “for instance,” “such as,” “for example” (“e.g.,”), and the like, is merely intended to better illustrate the invention and does not indicate a limitation on the scope of the invention unless specifically so claimed.

Those skilled in the art will readily observe that numerous modifications and alterations of the system and apparatus may be made while retaining the invention's teachings. Accordingly, the above disclosure should be construed as limited only by the metes and bounds of the appended claims.

What is claimed:

1. A fast fiber optic switching system with greater than 144 total ports, the system comprising:
a large-scale robotic fiber optic patch-panel system; and
a multiplicity of fast OCS (optical circuit switches) units, each unit with X fibers that can be reconfigured in parallel and within less than 10 seconds, and with the fibers of each fast OCS unit spliced to an equal number of input fibers of the robotic fiber optic patch-panel system,
wherein the robotic fiber optic patch panel system has Y ports and can reconfigure each port in about one minute in a serial fashion, and
wherein the system provides reconfigurable, any-to-any connectivity between the Y ports, and
wherein Y is at least 2 times X.

2. The fiber optic switching system of claim 1, wherein Y is about 2,040, and X is about 136.

3. The fiber optic switching system of claim 1, wherein the Y ports of the robotic fiber optic patch-panel correspond to simplex fiber ports with Y robotically reconfigurable fibers.

4. The fiber optic switching system of claim 1, wherein the Y ports of the robotic fiber optic patch-panel correspond to duplex fiber ports with 2Y robotically pairwise reconfigurable fibers.

5. The fiber optic switching system of claim 1, wherein a batch of reconfiguration commands can be executed in parallel within about one minute.

6. The fiber optic switching system of claim 1, wherein any of the X fibers can be connected to any of the Y ports.

7. The fiber optic switching system of claim 1, wherein insertion loss for all fibers of the fiber optic switching system is less than the insertion loss of an individual fast OCS unit with Y fibers.

8. The fiber optic switching system of claim 1, further including a fiber-optic connector end-face cleaning system within the robotic fiber patch panel to maintain low insertion loss.

9. The fiber optic switching system of claim 1, further including a fiber optic connector inspection system comprised of an OTDR (Optical Time Domain Reflectometer) that measures insertion loss and reflections within the fiber optic switching system and extending out through external cables attached to the robotic patch-panel.

10. The fiber optic switching system of claim 1, wherein the fast optical circuit switches comprise one or more MEMS (Micro-Electro-Mechanical Systems) mirror arrays and/or, one or more collimator arrays, and/or multiple opposing piezoelectric beam steering collimators.

11. The fiber optic switching system of claim 1, wherein fibers of the fast optical circuit switches are fusion-spliced to the large-scale robotic patch-panel system.

12. A fiber optic switching system with greater than 144 ports, the system comprised of a multiplicity of fast optical circuit switch (OCS) units with X fibers, wherein
insertion loss of fast OCS units to switch X internal fibers increases in proportion to the number X, and
the fibers of each fast OCS unit are spliced to an equal number of input fibers of a large-scale robotic fiber optic patch panel, and
the insertion loss of the robotic fiber optic patch panel with a number Y internal, independently reconfigurable fibers is independent of the number Y of fibers, and
the fiber optic switching system enables any-to-any connectivity between the Y fibers, wherein Y is at least 2 times X, and
wherein the insertion loss of the fiber optic switching system is less than what would be possible for a Y port fast OCS unit alone.

13. The system of claim 12, wherein the insertion loss of each fast OCS is greater than 1 dB, and the insertion loss of the robotic fiber optic panel is less than 1 dB.

14. The system of claim 12, further including a fiber-optic connector end-face cleaning system to maintain low insertion loss.

15. The system of claim 12, further including a fiber optic connector inspection system comprised of an OTDR (Optical Time Domain Reflectometer) that measures the insertion loss and reflections within the fiber optic switching system and extending out through external cables attached to the robotic patch panel.

16. The system of claim 12, wherein Y is about 2,040, and X is about 136.

17. The system of claim 12, wherein the fast OCS units comprise MEMS mirror arrays and/or collimator arrays and/or multiple opposing piezoelectric beam steering collimators.

18. The system of claim 12, wherein fibers of the fast optical circuit switches are fusion-spliced to the large-scale robotic patch-panel.

19. A high port count, fast fiber optic switching system with greater than 144 total ports, the system comprising:
a multiplicity of fast optical circuit switch (OCS) units, each unit with X fibers, the fibers of each fast OCS unit spliced to an equal number of input fibers of a large-scale robotic fiber optic patch-panel system comprising a connector array with Y ports, wherein a time to reconfigure a port is an additive combination comprised of:
(i) a first switching time t1 of the fast OCS to change all connections in a substantially parallel fashion,
(ii) a second switching time t2 of the robotic patch-panel to change connections within a column of the connector array in a serial fashion, and
(iii) a third switching time t3 of the robotic patch panel to pass connections across a column of the connector array in a serial fashion.

20. The system of claim 19, wherein t1 is about 10 ms, t2 is about 25 seconds, and t3 is about 10 seconds per column passed.

21. The system of claim 19, wherein fibers of the fast OCS units are fusion-spliced to the large-scale robotic patch-panel system.
